(19) United States
(12) Patent Application Publication
(10) Pub. No.: US 2008/0273345 A1
(43) Pub. Date: Nov. 6, 2008

(54) Lamp for vehicle

(75) Inventors: Yasuo Yajima, Isehara-shi (JP); Satoru Okada, Isehara-shi (JP)

Correspondence Address: FOLEY AND LARDNER LLP;SUITE 500, 3000 K STREET NW, WASHINGTON, DC, 20007, US

(73) Assignee: ICHIKOH INDUSTRIES, LTD.

(21) Appl. No.: 11/905,858

(22) Filed: Oct. 4, 2007

(30) Foreign Application Priority Data
Oct. 6, 2006 (JP) 2006-274790

(51) Int. Cl. F21V 7/00

(52) U.S. Cl. 362/517

(57) ABSTRACT

A lamp for a vehicle, includes a first reflector which forms a reflecting plane inclining to an optical axis disposed at a position opposed to a light source; a second reflector which is arranged at a light source side and reflects light reflected by the first reflector; and an outer lens which transmits light reflected by the second reflector, the first reflector being extended lengthwise, and being formed integrally with the second reflector, a slit being provided at a position of the second reflector opposed to the first reflector, and the light of the light source being emitted through the slit.

### BACKGROUND OF THE INVENTION

1. Field of the Invention

The present invention relates to a lamp for a vehicle, such as a lamp for a side mirror, a fog lamp, a tail lamp, and a head lamp which are equipped on a car.

2. Description of the Related Art

Conventionally, it is known that a structure such as a side mirror, which is an outside mirror of a vehicle, is provided with a lamp unit having a blinking function at a lateral surface of the side mirror (refer to, for example, JP 2000-315406 A, JP 2002-19519 A).

Usually a small light-emitting diode (LED) is selected as a light source since the lamp unit is arranged in a narrow space such as the side mirror.

On the other hand, due to an illuminating angle of the LED being narrower than that of an incandescent electric lamp or the like, when a plurality of LEDs are arranged at a luminescence part which extends in a lateral direction, it is possible for each of the LEDs to appear as an independent light source, and the plurality of LEDs are not recognized as one lamp.

Therefore, in a lamp for a vehicle disclosed in JP 2000-315406 A, an illuminating angle is broadened by arranging a hyperboloid mirror in front of an LED, and reflecting light reflected by the hyperboloid reflector again by a parabolic reflector located on an LED side.

However, when the two reflectors are used for the lamp as mentioned in JP 2000-315406 A, if the reflectors which make a pair are not attached with an accurate positional relationship, a desired illuminating angle can not be obtained.

Moreover, when a main body of the reflector is formed of a resin, and a reflecting surface is formed on a surface of the main body by aluminum evaporation, it is hard to perform work in manufacturing at a position opposed to the LED and difficult to finish the reflector finely.

### SUMMARY OF THE INVENTION

At least one object of the present invention is to provide a lamp for a vehicle, which is capable of being fitted with reflectors which make a pair arranged with an accurate positional relationship and which can be finished finely.

In light of the above, according to an aspect of the present invention, a lamp for a vehicle includes: a first reflector which forms a reflecting plane inclining to an optical axis disposed at a position opposed to a light source; a second reflector which is arranged at a light source side and reflects light reflected by the first reflector; and an outer lens which transmits light reflected by the second reflector, the first reflector being extended lengthwise, and being formed integrally with the second reflector, a slit being provided at a position of the second reflector opposed to the first reflector, and the light of the light source being emitted through the slit.

According to another aspect of the present invention, a lamp for a vehicle includes: a plurality of light sources; a plurality of first reflectors each of which forms a reflecting plane inclining to an optical axis disposed at a position opposed to each of the plurality of light sources respectively; a plurality of second reflectors each of which is arranged at a light source side and reflects light reflected by each of the plurality of first reflectors, respectively; and an outer lens which transmits light reflected by the plurality of second reflectors, each of the plurality of first reflectors being extended lengthwise, a slit being provided at a position of each of the plurality of second reflectors opposed to each of the plurality of first reflectors, and the light of each of the plurality of light sources being emitted through each slit.

Here, it is possible to arrange the plurality of light sources at an interval in a direction substantially perpendicular to a longitudinal direction of the first reflector.

In addition, it is preferable that the first reflector be provided with reflecting planes which emit reflected light towards reflecting surfaces of the second reflector located on both sides across the slit.

### BRIEF DESCRIPTION OF THE DRAWINGS

The invention will be described further below with reference to embodiments and the accompanying schematic drawings, in which:

FIG. 1 is a sectional perspective view illustrating a structure of a circumference of an LED disposed at a lamp for a side mirror according to an embodiment of the invention;

FIG. 2 is a front view illustrating a structure of the lamp for the side mirror according to the embodiment of the invention;

FIG. 3 is a sectional view along A-A direction of FIG. 2; and

FIG. 4 is a partially enlarged sectional view illustrating paths of light emitted from the LED according to the embodiment of the invention.

### DETAILED DESCRIPTION OF THE PREFERRED EMBODIMENTS

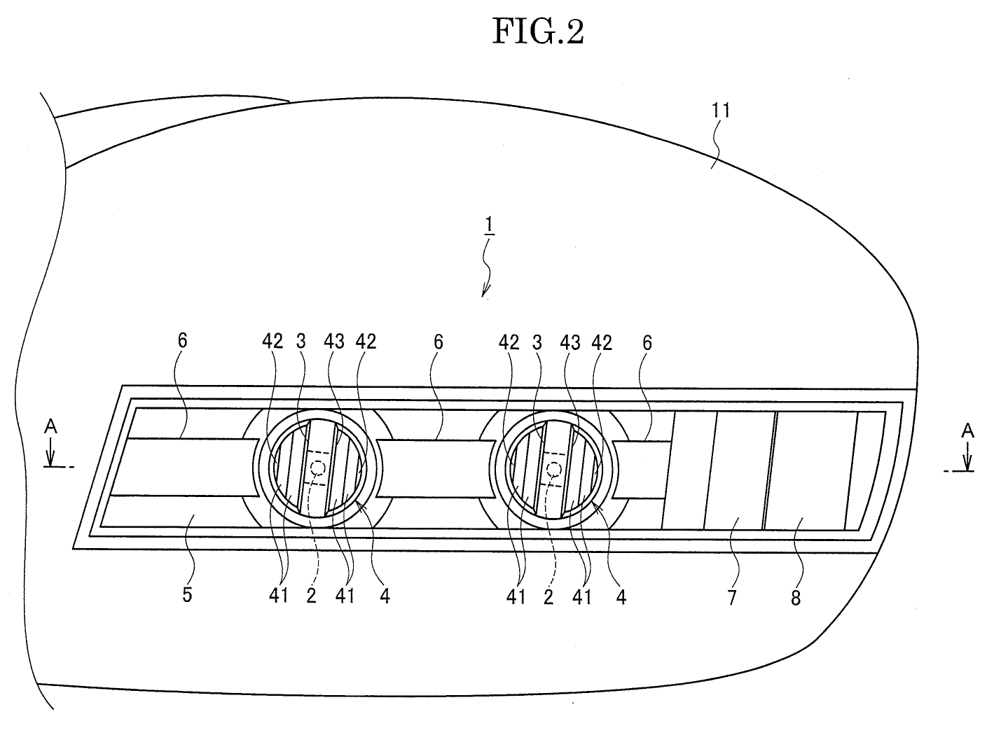

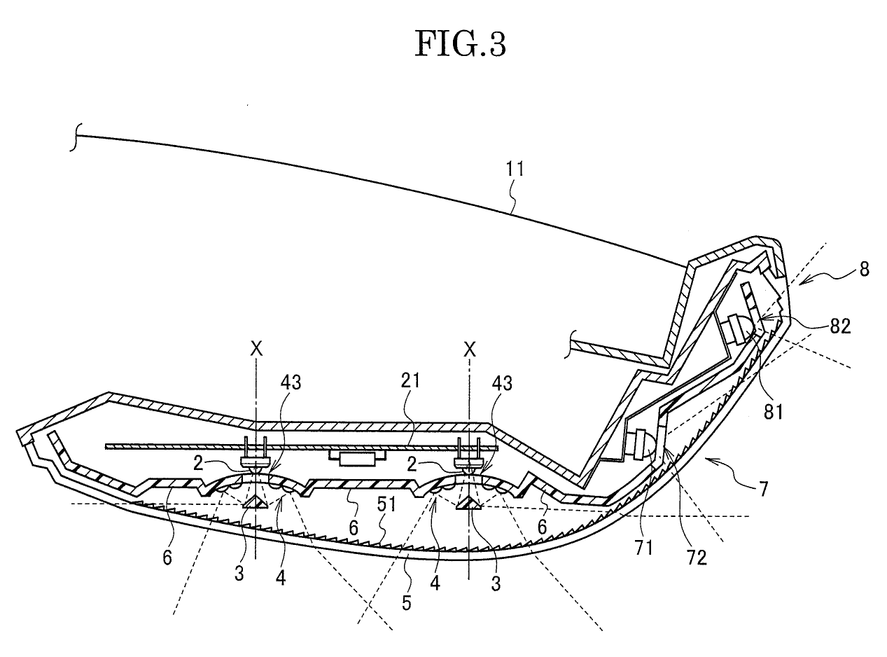

FIG. 2 is a figure illustrating a structure of a lamp 1 for a side mirror, as a lamp for a vehicle, according to an embodiment of the present invention, and FIG. 2 is a front view of the lamp 1 for the side mirror which is disposed at a side mirror 11 located on a right side towards the vehicle. In addition, FIG. 3 is a sectional view along A-A direction of FIG. 2.

The lamp 1 for the side mirror according to the embodiment of the present invention includes two LEDs 2, 2 which are facing front, as light sources; a side luminescence part 7 and a further rearward luminescence part 8 which form a second luminescence part continued to a first luminescence part formed by the LEDs 2, 2; and an outer lens 5 which covers these luminescence parts.

As illustrated in FIG. 3, the outer lens 5 is a lens which at its inner face side includes a prism section 51 having a plurality of approximately right-angled triangle shapes viewed in section, the outer lens 5 diffusing incident light further and controlling such that outgoing light appears to shine continuously. In addition, a circuit board 21 is provided to mount such as an LED element and a resistor.

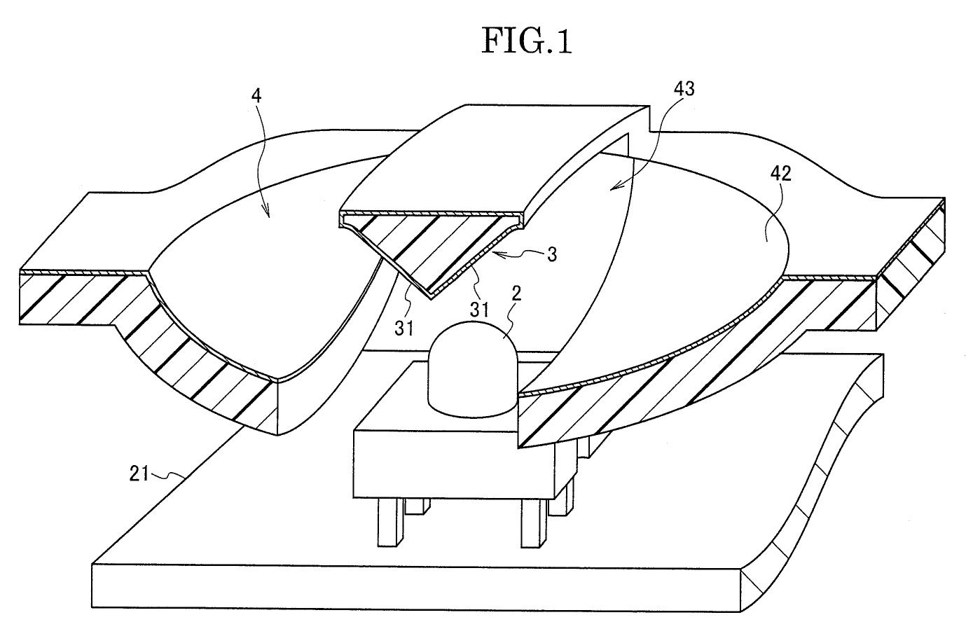

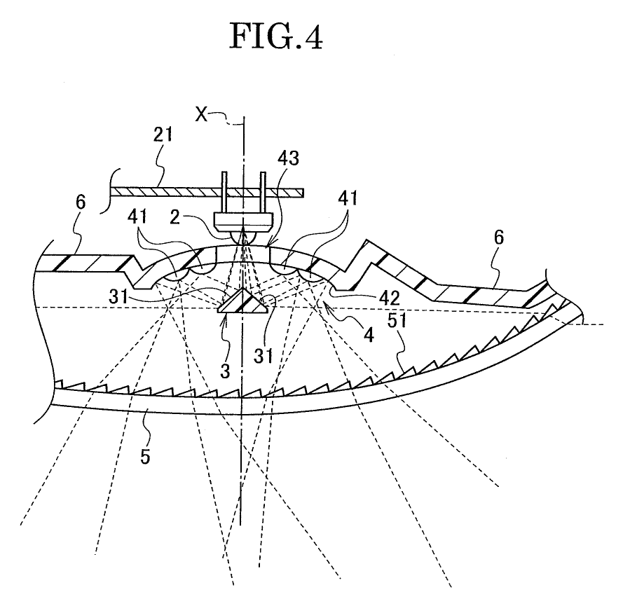

Then, as illustrated in FIG. 1, a length flat reflector 3 (a first reflector) formed to be an arch shape is arranged at a position opposed to one of the two LEDs 2, 2. The flat reflector 3 is formed with two reflecting planes 31, 31 which incline to an optical axis X, as illustrated in FIG. 4.

That is to say, the reflecting planes 31, 31 are formed to be line symmetrical about the optical axis X such that their edge parts on the LED 2 side intersect the optical axis X, and their edge parts on the outer lens 5 side are extended, as illustrated in FIG. 4.

And, as illustrated in FIG. 4 by broken lines, reflected light reflected by one of the reflecting planes 31, 31 which is disposed on the right side of the optical axis X, is reflected again by a second reflector 4 at a part which is on a right side of a slit 43, and reflected light reflected by another one of the reflecting planes 31, 31 which is disposed on the left of the optical axis X, is reflected again by the second reflector 4 at a part which is on the left side of the slit 43.

As illustrated in FIG. 1, the second reflector 4 has a reflecting surface formed to be a shape of paraboloid of revolution, and the slit 43 is formed at a position of the second reflector 4 opposed to the flat reflector 3 such that it divides the second reflector 4 into two parts.

As illustrated in FIG. 2, the slit 43 is formed with such a width and length that it is almost hidden by the flat reflector 3 when viewing it from a front. In other words, the slit 43 is formed such that a total length of each of the reflecting planes 31, 31 is visible from the LED 2 side through the slit 43, as illustrated in FIG. 1.

Main bodies of the flat reflector 3 and the second reflector 4 are formed with a resin integrally, for example, an upper face of the second reflector 4 is shaped at a lower surface of an upper mold, and the reflecting planes 31, 31 of the flat reflector 3 are shaped at an upper surface of a lower mold.

Then, a reflection processing of the reflecting planes 31, 31 and a reflecting paraboloid 42 is performed by aluminum evaporation or the like to a surface of the integrally formed resin member.

When performing the reflection processing of the reflecting planes 31, 31, by using the slit 43, it is possible to provide good workability over the total length of each of the planes 31, 31 and finish the processing finely.

In addition, as illustrated in FIGS. 2 to 4, the reflecting paraboloid 42 is provided with a plurality of prisms 41, . . . , 41 each of which has a semicircle section. The prisms 41, . . . , 41 are extended in a direction approximately the same as the flat reflector 3 and the slit 43, viewed from the front, as illustrated in FIG. 2.

The flat reflector 3 and the second reflector 4 as mentioned-above are provided to another one of the two LEDs 2, 2 disposed adjacent to the one LED 2 as well, as illustrated in FIG. 2.

Moreover, the second reflectors 4 and 4 are connected by a connection part 6 which has a rectangular shape, and the reflection processing is performed on a surface of the connection part 6 as well.

Further, as illustrated in FIG. 3, a high luminance LED 71 is arranged at the side luminescence part 7 which is connected through the connection part 6, and irradiation is performed from an opening 72 towards a lateral direction of the vehicle. Moreover, a high luminance LED 81 is arranged at the further rearward luminescence part 8, and irradiation is performed from an opening 82 towards the rear of the vehicle. In the lamp 1, by the LEDs 71 and 81, an irradiation range required by regulations is satisfied.

In addition, the outer lens 5 integrally formed and arranged in front of the LEDs 2, 2, is arranged at the side luminescence part 7 and the further rearward luminescence part 8, and by light emitted from these luminescence parts, the entire outer lens 5 emits light like one lamp.

Next, functions of the lamp 1 for the side mirror according to the embodiment of the present invention will be explained with reference to FIG. 4.

Broken lines in FIG. 4 illustrate paths of light emitted from the LED 2, and light emitted from the LED 2 towards a front of the vehicle is incident on the two reflecting planes 31, 31 of the flat reflector 3.

Then, the light reflected by the reflecting planes 31, 31 is directed towards the second reflector 4, and reflected again by the reflecting paraboloid 42 or the prisms 41, . . . , 41 arranged at its surface, and then the light is emitted towards the outer lens 5.

That is to say, for a primary illuminating angle emitted from the LED 2, the light is only broadened to a width degree of the flat reflector 3 at a position of the flat reflector 3, and the light reflected by the flat reflector 3 is broadened to a width degree of the second reflector 4.

And, the light reflected again by the prisms 41, . . . , 41 or the reflecting paraboloid 42 is broadened greatly compared to the primary illuminating angle of the LED 2, and is emitted to the outer lens 5, and then the light is controlled to be continuous light by the outer lens 5 and emitted out.

In this way, when each illuminating angle of the LEDs 2, 2 is broadened and the light is emitted through the outer lens 5, as illustrated by broken lines in FIG. 3, light emitted from a leftmost LED 2 is emitted through the outer lens 5 and overlaps with light emitted from a LED 2 on a right neighbor of the leftmost LED 2, and it appears that the light is emitted from one light source.

Moreover, light emitted from a second LED 2 from the left side of the lamp 1 overlaps with the light emitted from the side luminescence part 7, and it appears like one light source.

In addition, the side luminescence part 7 and the further rearward luminescence part 8 are neighboring, therefore light emitted through the outer lens 5 is overlapped when viewed, even if the light is not reflected twice.

In this way, when light emitted through the outer lens 5 which is from a plurality of adjacent light sources can be overlapped, it appears that the entire outer lens 5 emits lights as one lamp.

In the lamp 1 structured as such for the side mirror according to the embodiment of the present invention, the flat reflector 3 formed at the position opposed to the LED 2 and the second reflector 4 facing the flat reflector 3 are formed integrally. In addition, the slit 43 is extended at the position opposed to the flat reflector 3, which has a long shape.

Therefore, it is possible to form an accurate positional relationship of the flat reflector 3 and the second reflector 4 which form a pair, comparing to a case of attaching the two parts.

Moreover, since it is possible to form the reflecting planes 31, 31 by using the slit 43 which is provided along the flat reflector 3, the workability is excellent and the reflector is able to be finished finely.

In addition, since the slit 43 is hidden behind the flat reflector 3, the appearance is not affected due to the space not being visible even when viewed from outside. Moreover, the LED 2 as the light source is invisible due to the flat reflector 3, therefore illuminance of the light emitted through the outer lens 5 is made uniform and has few irregularities.

In addition, by arranging another LED 2 in a direction in which the illuminating angle is broadened by the flat reflector 3, even if an arrangement interval of the LED 2 is widened, it is possible to recognize the plurality of the LEDs 2, . . . , 2 as one lamp.

Moreover, the reflecting planes 31, 31 of the flat reflector 3 are formed relative to the reflecting faces of the second reflector 4 located at both sides of the slit 43, thus it is possible to diffuse light right and left centering an the LED 2 efficiently, and broadeu the illuminating angle.

Although the present invention has been described in terms of exemplary embodiments, it is not limited thereto. It should be appreciated that variations may be made in the embodiments described by persons skilled in the art without departing from the scope of the present invention as defined by the following claims.

For example, in the above-mentioned embodiment, as the lamp for the vehicle, the case of the lamp 1 for the side mirror is explained, but it is not limited to this, and it is possible to apply the present invention to a lamp for a vehicle such as a fog lamp, a tail lamp, and a head lamp.

In addition, in the above-mentioned embodiment, as the light source the LED 2 is explained, but it is not limited to this, and it is possible to use such as a semiconductor-type light source which utilizes an organic semiconductor such as a high luminance LED and an organic EL (electroluminescence), a semiconductor laser (LD), and an incandescent electric lamp, as the light source.

Moreover, in the above-mentioned embodiment, a structure which has four light sources (the LEDs 2, 2 and the high luminance LEDs 71, 81) and appears like one lamp is explained, but it is not limited to this, and it is possible to apply the present invention to cases where an illuminating angle of one light source is broadened, and each illuminating angle of any light sources is broadened individually.

Furthermore, in the above-mentioned embodiment, a plurality of the prisms 41, . . . , 41 are arranged at the surface of the reflecting paraboloid 42, but it is not limited to this, and an embodiment which does not use the prism 41 is possible, and an embodiment having a structure which has a similar shape to the prism 41 and on the resin surface thereof reflection processing is performed, is also possible.

In addition, in the above-mentioned embodiment, the case in which two tilting reflecting planes 31, 31 are provided to the flat reflector 3 and the illuminating angle is broadened right and left is explained, but it is not limited to this, for example, it is possible to use such a structure that includes a flat reflector which has one reflecting plane intersecting with the optical axis X at an angle, and only an illuminating angle of one side being broadened by the flat reflector.

The entire contents of Japanese patent application No. JP 2006-274790, filed on Oct. 6, 2006, of which the convention priority is claimed in this application, are incorporated hereinto by reference.

What is claimed is:

1. A lamp for a vehicle, comprising:
a first reflector which forms a reflecting plane inclining to an optical axis disposed at a position opposed to a light source;
a second reflector which is arranged at a light source side and reflects light reflected by the first reflector; and
an outer lens which transmits light reflected by the second reflector,
the first reflector being extended lengthwise, and being formed integrally with the second reflector, a slit being provided at a position of the second reflector opposed to the first reflector, and the light of the light source being emitted through the slit.

2. A lamp for a vehicle, comprising:
a plurality of light sources;
a plurality of first reflectors each of which forms a reflecting plane inclining to an optical axis disposed at a position opposed to each of the plurality of light sources respectively;
a plurality of second reflectors each of which is arranged at a light source side and reflects light reflected by each of the plurality of first reflectors, respectively; and
an outer lens which transmits light reflected by the plurality of second reflectors,
each of the plurality of first reflectors being extended lengthwise, a slit being provided at a position of each of the plurality of second reflectors opposed to each of the plurality of first reflectors, and the light of each of the plurality of light sources being emitted through each slit.

3. A lamp for a vehicle according to claim 2, wherein the plurality of light sources are arranged at an interval in a direction substantially perpendicular to a longitudinal direction of the first reflector.

4. A lamp for a vehicle according to claim 1, wherein the first reflector is provided with reflecting planes which emit reflected light towards reflecting surfaces of the second reflector located on both sides across the slit.

5. A lamp for a vehicle according to claim 2, wherein the first reflectors is provided with reflecting planes which emit reflected light towards reflecting surfaces of the second reflectors located on both sides across the slit.
